(19) United States
(12) Patent Application Publication
(10) Pub. No.: US 2017/0140615 A1
(43) Pub. Date: May 18, 2017

(54) MODULAR CASH REGISTER

(71) Applicant: Ingenico Group, Paris (FR)

(72) Inventors: Alexandre LARNAC, Le Pellerin (FR); Camille GOMBAULT, Bures sur Yvette (FR); Philippe DEDIEU, Guilheran-Granges (FR); Cédric DECODTS, Roybon (FR); Fabien DEMANGE, Saint Peray (FR); Didier GEORGES, Chabeuil (FR)

(21) Appl. No.: 15/349,181

(22) Filed: Nov. 11, 2016

(30) Foreign Application Priority Data
Nov. 13, 2015 (FR) 1560914

(51) Int. Cl. G07G 1/00; G06K 7/10

(52) U.S. Cl. CPC G07G 1/0018; G07G 1/0009; G06K 7/1098; G06F 3/1243

(57) ABSTRACT

The proposed technique relates to cash register implemented by means of a tablet type digital touchpad device (400). The digital touchpad device (400) is fixed to a main module (100) that comprises:

a central unit (102);

an interchangeable support (107) adapted to maintaining said digital touchpad device (400);

a hinged arm (110), of which one of the extremities, called a first extremity, is linked by a first pivot link (111) to said central unit (102), and of which the other extremity, called a second extremity, is linked by a second pivot link (112) to a receiving plate to which said interchangeable support (107) is fixed.

The proposed cash register is modular, and it optionally comprises an optical reader module and/or a payment module on which a payment terminal is positioned.

### BACKGROUND OF THE INVENTION

Field of the Invention

The field of the invention is that of cash registers. The invention relates more particularly to the field of cash registers that incorporate tablet type digital touchpad devices.

Description of the Related Art

There are known classic cash registers which take the form of an integrated device generally comprising an alphanumeric keypad, a screen that is possibly a touch screen and, depending on the models, capable of including several complementary elements such as a cash till or again a barcode reader. With these conventional cash registers, the merchant of course has a tool that is sufficient to carry out the cash-register operations related to his activity but often proves to be bulky, costly and difficult to upgrade. It is, for example, difficult to adapt these classic devices to different counter configurations and their monobloc, static nature is such that a merchant who wishes to develop his activity or his business often has no choice but to totally replace a cash register that has become unsuited to his new requirements.

The great expansion of the use of touchpad tablets, which are ever increasingly powerful, connected and compact and yet have comfortable-sized screens, has enabled the development of novel uses, especially in professional circles. Solutions aimed at replacing conventional cash registers by touchpad tablets integrating adapted cash register software have thus emerged. These solutions offer numerous advantages as compared with conventional cash registers: they are less costly, more compact and the embedded cash-register software can be easily updated when new functions become available. In addition, they offer the merchant greater flexibility by enabling him for example to prefer a solution based on a touchpad tablet model that is familiar to him and which he knows well for using it in another context. Besides the touchpad tablet, a device that is mobile and connected by nature opens up novel working opportunities: this cash register of a new type is no longer necessarily attached to the premises of a business, and the merchant can for example easily carry it home or take it to his accountant to prepare his various business reports. However, a touchpad tablet is not generally enough in itself to carry out a cash register solution functional and reliable enough to meet the merchant's needs. Thus, for practical reasons, it is advantageous to install the tablet on a suitable support on the counter. Besides, depending on the activity being carried out by the merchant, making the installation operational generally requires the addition of various complementary elements, such as, for example, a barcode reader, a payment terminal or again a thermal printer to print out cash receipts. These considerations are not without constraints. Thus, the supports of existing tablets are generally compatible with a limited number of tablets, which can raise problems when a merchant wishes to change his model of tablet. Besides, when such a cash register includes not only the touchpad tablet and its support but also complementary elements essential to the merchant's activity, it forms a diversified assembly that is not integrated and proves to be not only lacking in aesthetic quality but also unsuited to the requirements of compactness related to certain businesses. In addition, the tablet generally does not have security devices complying with the standards in force: it is therefore unwise to entrust a tablet with the entire management of the cash desk.

The present solutions used for cash registers therefore have certain drawbacks with, on the one hand, integrated classic cash registers that are bulky, costly and unchanging, and on the other hand cash registers based on touchpad-tablet type digital devices that are easier to upgrade but often are inconsistent and sometimes entail constraints in terms of compatibility when complementary elements, essential to a given form of activity, have to be added to them.

There is therefore a need for cash registers that meet the requirements of both modularity and upgradable quality required by merchants while nevertheless offering certain guarantees as regards to the consistency and lastingness of the solution chosen.

### SUMMARY OF THE INVENTION

The proposed technique offers a solution that does not have some of these drawbacks of the prior art through a modular cash register implemented by means of a tablet type digital touchpad device.

According to a first aspect, the proposed technique relates to a main module of a cash register implemented by means of a digital touchpad tablet type of device. Such a main module comprises:

a central unit;

an interchangeable support adapted to maintaining said digital touchpad device;

a hinged arm, of which one of the extremities, called a first extremity, is linked by a first pivot link to said central unit, and of which the other extremity, called a second extremity, is linked by a second pivot link to a receiving plate to which said interchangeable support is fixed.

Thus, the replacement of the digital touchpad device by another model of digital touchpad device does not require the replacement of the entire main module: only the interchangeable support has to be replaced by another interchangeable support adapted to the new model of digital touchpad device chosen. Besides, the inclination of the digital touchpad device can be set to its user's convenience by means of the hinged arm.

In one particular embodiment of the proposed technique, the central unit integrates a printer and has a slot on one of its faces as an outlet slot for print-outs from said printer, as well as a hatch for access to a housing for loading at least one paper roll for said printer.

In this way, the main module comprises a printer integrated into the central unit enabling the printing of invoices and receipts related to the merchant's cash-register activity.

In another particular embodiment of the proposed technique, the first pivot link is a two-position pivot used to make the digital touchpad device tilt, by means of the hinged arm, into:

a first position, called a position of use, in which the digital touchpad device has an inclination favorable to its use.

a second position, called a loading position, in which the digital touchpad device is tilted in such a way that the access hatch to the housing for loading at least one printer paper roll is accessible.

Thus, the first pivot link releases the access to the housing for loading the paper rolls of the printer without losing the setting of the inclination of the digital touchpad device made by means of the second pivot link. The inclination chosen by the merchant in the position of use is therefore kept even when the merchant needs to load a new paper roll into the dedicated housing.

In yet another particular embodiment of the proposed technique, said second extremity of the hinged arm and said receiving plate are furthermore linked by a third pivot link enabling the rotation of said receiving plate and therefore of said digital touchpad device in its plane of inclination.

In this way, the digital touchpad device can be oriented in portrait mode or in landscape mode according to the requirements of the merchant without any modification of its inclination of use pre-set by the merchant using said second pivot link.

In another particular embodiment of the proposed technique, the central unit comprises means for attaching an additional screen.

Thus, in addition to the screen of the digital touchpad device, an additional optional screen, intended for the customers, can be fixed to the central unit of the main module. An adapted cover can be used to mask said attachment means and preserve the consistent aspect of the cash register when the merchant does not wish to use any additional screen.

According to a second aspect, the proposed technique also relates to a payment module to be coupled to a main module of a cash register as described above. This payment module comprises a receiving base for the payment terminal, said base comprising:

a lower part;

an upper part comprising a housing capable of receiving said payment terminal, said upper part being linked by a pivot link to said lower part, said pivot link enabling said upper part to pivot in the substantially horizontal plane on said lower part.

Thus, the base for receiving the payment terminal is a pivoting base, which enables the payment terminal to be oriented towards the merchant or towards the customer as required, even when this base is fixed to the frame or to the main module of a cash register according to the proposed technique, for example.

According to yet another aspect, the proposed technique also relates to an optical reader module to be coupled to a main module of a cash register as described above. This optical reader module comprises:

a first part, called a fixed part;

a second part, called a detachable part, comprising an optical reader device,

said fixed and detachable parts comprising complementary means for the temporary, fixed attachment of said parts.

In this way, the optical reader device can be used in a fixed configuration when it is fixedly attached to the fixed part (which can be fixed to the frame or to a cash register for example) or in a mobile configuration when it is not fixedly attached to the fixed part.

In one particular embodiment of the proposed technique, said complementary means of temporary fixed attachment of said fixed and detachable parts of the optical reader module take the form of complementary shapes capable of cooperating with each other and/or the form of magnets.

Thus, the passage from the fixed configuration to the mobile configuration and vice versa for the use of the optical reader device can be done speedily and simply. The magnets ensure that the detachable part is properly held to the fixed part while permitting fast detachment and the complementary shapes ensure that the detachable part is always centered accurately on the fixed part when the two parts are fixedly attached. This ensures that the optical reader device can be used in its fixed configuration, while still maintaining a consistent appearance for the cash register.

In yet another aspect, the proposed invention relates to a cash register implemented by means of a tablet type digital touchpad device, characterized in that said digital touchpad device is fixed to a main module as described here above and said cash register optionally comprises:

a payment module as described above, on which a payment terminal is positioned; and/or

an optical reader module as described above.

Thus, an upgradable cash register is available, having great modularity, capable of being speedily and simply adapted in order to meet different requirements proper to each merchant.

The different embodiments mentioned above can be combined with one another to implement the proposed technique.

### BRIEF DESCRIPTION OF THE DRAWINGS

Other features and advantages of the proposed technique shall appear more clearly from the following description of a preferred embodiment of this technique, given by way of an illustratory and non-exhaustive example and from the appended figures of which:

FIG. 1 presents a three-quarter view or view in perspective of the different modules of a cash register according to one particular embodiment of the proposed technique;

FIG. 2 presents a three-quarter view of the main module of a cash register seen from the merchant's side in one particular embodiment of the proposed technique;

FIG. 3 presents a three-quarter view of the different modules of a cash register seen from the customer's side in one particular embodiment of the proposed technique;

FIG. 4 presents a three-quarter view of a payment module in one particular embodiment of the proposed technique;

FIG. 5 presents the detachable part of an optical reader module in one particular embodiment of the proposed technique;

FIG. 6 presents a diagram of the layout of the fixed and detachable parts of an optical reader module in one particular embodiment of the proposed technique;

FIG. 7 presents a three-quarter view of a cash register in another embodiment of the proposed technique.

FIG. 8a presents a three-quarter view of a cash register in yet another embodiment of the proposed technique.

FIG. 8b presents a view of the cash register of FIG. 8a with a hatch of the cash register open for replacement of a paper roll.

FIG. 9a presents a three-quarter view of a cash register in still another embodiment of the proposed technique.

FIG. 9b presents a view of the cash register of FIG. 9a with a fastening means cover removed.

FIG. 9c presents a view of the cash register of FIGS. 9a and 9b with an additional screen provided.

FIG. 10a presents a three-quarter view of a cash register in yet a further embodiment of the proposed technique.

FIG. 10b presents a view of the cash register of FIG. 10a with components thereof in alternative orientations.

### DETAILED DESCRIPTION

As indicated above, the invention therefore relates to a modular cash register capable of offering a solution to the requirements proper to each merchant. In all the figures of the present document, identical elements are designated by a same numerical reference.

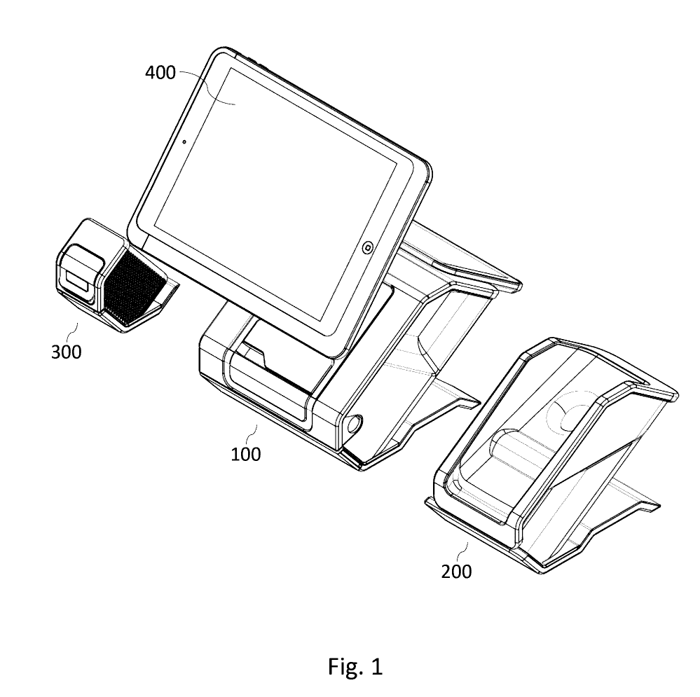

Referring to FIG. 1, a three-quarter view is presented of the different modules that can be implemented to form a cash register according to the proposed technique. Such a cash register comprises a main module (100) which can receive a mobile digital device (400) such as a touchpad tablet or a smartphone for example, on which a cash-register software program is installed. Optionally, a cash register according to the proposed technique comprises complementary modules such as a payment module (200) and/or an optical reader module (300). In the rest of this document, the digital device (400) used to execute the cash-register software program is considered to be a touchpad tablet, but this example is given purely by way of an illustratory and non- exhaustive example.

These different modules and the way in which they are organized to form a cash register according to the proposed technique are described below.

### 5.1 Main Module

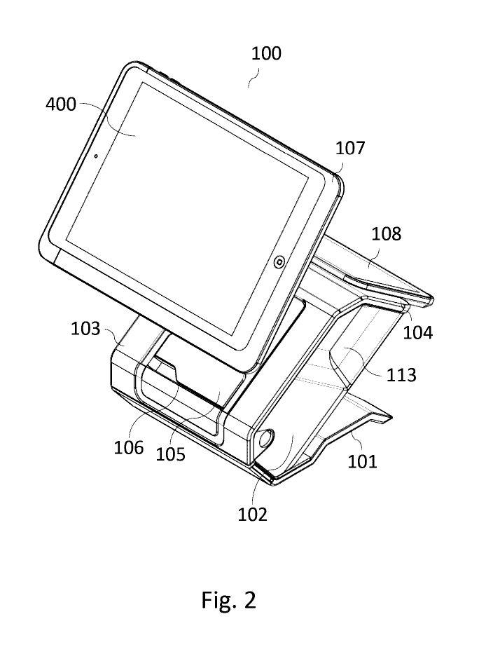

Referring to FIG. 2, we present an example of a main module (100) in one particular embodiment of the proposed technique. This main module (100) and the touchpad tablet (400) that is installed therein form the core of the cash register according to the proposed technique.

The main module (100) comprises a foot (101) fixedly attached to a central unit (102) with a generally parallelepiped shape. The foot (101) is to be laid or fixed on an element of the frame, for example on the counter of a merchant. The central unit (102) and its foot (101) are laid out in such a way that they mutually form an acute angle. In this way, the front face (103) and the top face (104) of the central unit (102) form surfaces that are easily visible and accessible respectively to a merchant and a customer situated on either side of a counter where said cash register is positioned.

In one particular embodiment of the proposed cash register that has optimized integration, the central unit (102) contains a printer and a hatch (105) is made in the front face (103) of said central unit. This hatch (105) enables access to a housing made in the central unit, capable of receiving at least one paper roll needed for the operation of the printer. A slot (106) is used to output printed receipts. This slot (106) can, for example, be made directly in the lower part of the access hatch (105) or again in the front face of the central unit (103) beneath the access hatch (105).

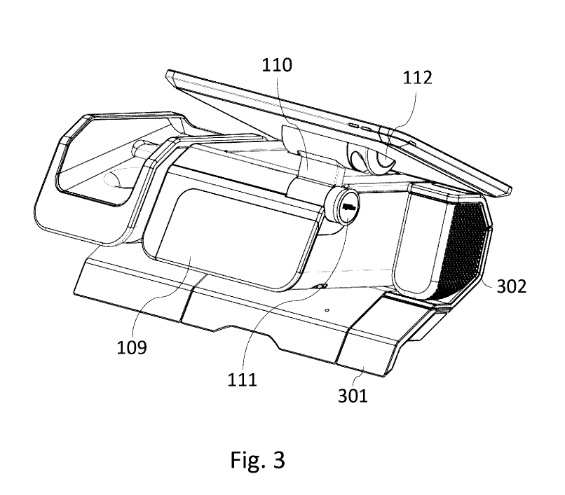

The main module (100) comprises a hinged arm (110) visible in FIG. 3 which is a rear three-quarter view of a cash register where a payment module and an optical reader module have been adjoined to the main module. This hinged arm (110) is fixed by one of its extremities to the central unit (102) by means of a first pivot link (111), in a junction zone between the front face (103) and the top face (104) of said central unit (102). The other extremity of the hinged arm (110) is linked by a second pivot link (112) to a receiving plate on which it is possible to fix an interchangeable support (107) for holding a touchpad tablet (400).

The first pivot link (111) is a two-position pivot which enables the total tilting of the touchpad tablet (400) and its support (107) between a position of use and a position known as a loading position. In the position of use, the surface of the touchpad tablet (400) faces the merchant who can therefore use it to perform ordinary cash-register operations related to his activity. In the loading position, the touchpad tablet (400) and its support (107) are tilted backwards and thus release the access to the front face of the central unit (102). The hatch (105) and the housing for loading paper for the printer that it shelters thus become accessible, enabling the merchant to easily load a new paper roll without being hindered in this operation by the touchpad tablet.

The second pivot link (112) is a multi-position pivot which enables the merchant to adjust the inclination of the tablet to his convenience so as to have optimal comfort of use when the touchpad tablet (400) is in the previously described position of use.

Contrary to a single-pivot solution, this mechanism based on two pivot links (111, 112) therefore enables the merchant to tilt the touchpad tablet into the paper-loading position through the first pivot link (111) without losing the setting of the inclination made by means of the second pivot link (112). Thus, when the merchant re-tilts the tablet into the position of use after for example having replaced the paper roll of the printer, he returns to the desired inclination of use.

In one particular embodiment of the proposed technique, a third pivot link can be implemented between the receiving plate and the extremity of the hinged arm that supports it. This two-position pivot, the rotational axis of which is perpendicular to the plane of the receiving plate, enables the tablet to be tilted into “portrait” or landscape” mode depending on the use desired, without modifying the inclination pre-set by the merchant using the second pivot link (112).

As described above, the proposed cash register makes it possible to receive a digital device of the merchant, typically a touchpad tablet. During the service life of the cash register, the merchant is liable to change his touchpad tablet. Thus, different supports are available, used to receive different models of tablets but also different types of digital devices (smartphones for example). All these supports are interchangeable inasmuch as they are all compatible with the receiving plate integrated into the main module of the cash register: they all have fastening means capable of cooperating with complementary fastening means of the receiving plate. Various fastening means can be envisaged (screwing, clipping, etc.). In one particular embodiment of the proposed technique, the fixed attachment of the tablet support (107) to its receiving plate does not require any tools and, for example, can be made by fitting one part of the receiving plate into an adapted recess of the support, followed by a rotational movement of the support (107) to complete the fixed attachment (the reverse operation will be used to detach the support from its receiving plate, again without tools).

The layout of the central unit (102) and of its foot (101) means that the top face (104) of the central unit is naturally oriented towards the customer who is facing a merchant, on the other side of the cash register according to the proposed technique. Thus, in one particular embodiment this surface (104) is particular suited to the installation of an additional optional screen (108) oriented towards the customer. The top face (104) of the central unit (102) therefore comprises attachment means capable of cooperating with complementary fastening means present on the back of such an additional screen (108). Advantageously, these fastening means are clip-on means used to attach the additional screen (108) to the central unit (102) speedily, easily and without tools. The use of such a screen is optional and this aspect therefore contributes to the modular character of the proposed cash register. A detachable cover (109) has, on its back, fastening means (for example clip-on means) complementary to those present on the top of the central processing unit and enables the merchant who does not wish to use an additional screen to mask the fastening means and therefore maintain a consistent appearance for the cash register on the customer side.

The main module also has at least one module for processing transactional data. Such a transactional data processing module takes for example the form of a combination of a processor (of the secured processor type) and a memory (which can also be secured). This module advantageously also comprises connection circuits and hardware interfaces with complementary modules (such as the complementary modules described below, for example a payment module and an optical reader module). This module offers processing functions (for example secured processing functions) for processing data circulating between the complementary modules (when they are installed) and data flowing between the cash register and the communications network with which this cash register is connected. More particularly, such a module can advantageously serve as an interface between the network of a payment service provider (such as a bank network) and a payment terminal connected to the main module by means of a network cable or a wireless network interface. Such a data-processing module can also serve as an interface with a touchpad tablet (400) in order to offer secured communication with this device. Thus, such an arrangement prevents theft or modification of the data managed by the touchpad tablet (400). According to one advantageous embodiment, the processing module embeds within it a relatively important part of a cash register management application and the touchpad tablet embeds the complementary part absent in the processing module so that the two parts recognize each other: thus the working of this cash register is secured.

According to another aspect of the invention, optional complementary modules can be adjoined to either side of the main module so as to extend the functions offered by the cash register. These complementary modules, which comprise a payment module and an optical reader module, are described here below.

### 5.2 Payment Module

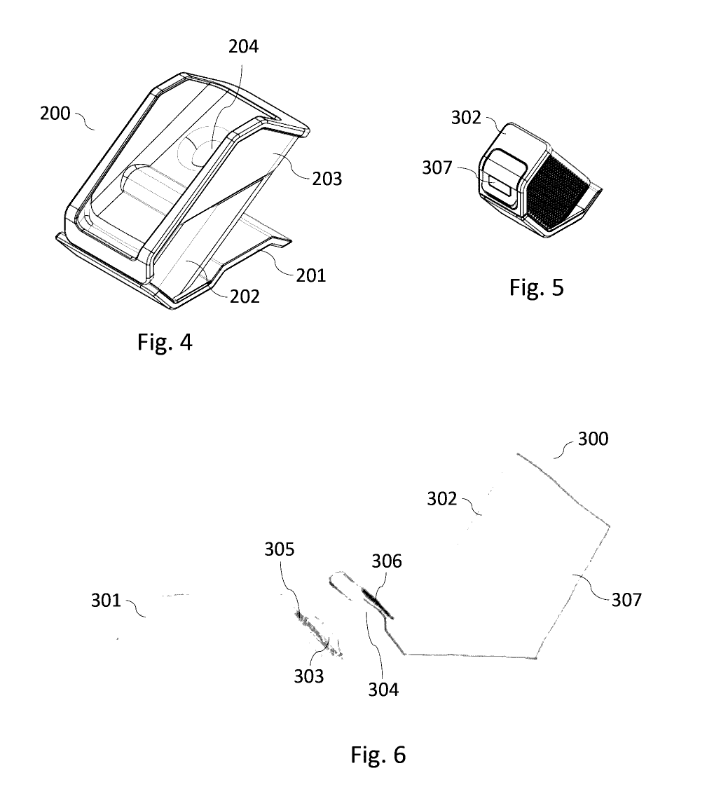

According to another aspect, the proposed technique also relates to a payment module that can be used jointly with the main module of the cash register described above. This payment module (200) is presented with reference to FIG. 4 in one particular embodiment. It comprises a base made of two parts (202, 203) mounted on a foot (201). This base is designed to receive a payment terminal (not shown in FIG. 4). The lower part (202) of this base is fixedly attached to its foot (201). The upper part (203) of the base has a housing in which the payment terminal can be installed. This upper part (203) is connected to the lower part (202) by a pivot link (204).

Depending on a merchant's needs (for example depending on the shape of the merchant's counter, the available space, etc.), the payment module (200) can be used in a configuration where it is fixedly attached with the main module (100) of the cash register, or again in another configuration where it is detached from the main module (100).

In its fixedly attached configuration, the fixed attachment of the payment module (200) with the main module (100) can for example be made by means of a linking part mounted beneath the foot (101) of the main module and beneath the foot (201) of the payment module and connecting the two feet (101, 201), with each other. Advantageously, these two feet (101, 201) have a same profile and, with the plane (or flat surface) on which they are placed, they form a space for the installation of this linking part. In this way, the linking part is out of sight once it is mounted. This space can also be profitably used for the passage of various cables. In addition to the similarity of the foot profiles (101, 201), the base of the payment module and its foot (201) advantageously form an angle between them that is similar to the angle formed between the central unit (102) and the foot (101) of the main module. In this way, the cash register maintains a consistent and integrated appearance when the payment module (200) is used in the configuration in which it is fixedly attached to the main module (100).

The pivot link (204) enables the upper part (203) of the base to pivot on its lower part (202) in a horizontal or nearly horizontal plane. Thus, even when the payment module (200) is fixedly attached with the main module (100), the payment terminal installed in this pivoting base can be oriented, as needed, towards the merchant or towards the customer by a 180° pivoting in the horizontal plane. The payment terminal also remains usable in all the intermediate positions between these two positions, which proves to be useful for certain particular configurations of the counter (where the customer is placed naturally on the merchant's side for example). So that the central unit (102) of the main module will not hinder the pivoting of the upper part (203) of the base on its lower part (202), the width of the base is smaller than the width of its foot (201). In this way, even when the feet (101, 201) of the main module (100) and of the payment module (200) are fixedly attached to each other, a space exists between the base of the payment module and the central unit (102) of the main module, which enables the upper part to freely pivot on an angular span at least greater than or equal to 180° (this space is for example seen in FIG. 7). In one particular embodiment of the proposed technique, for the cash register to be as compact and integrated as possible, a cavity (113) can be made on the side of the central unit (102) so as to limit the size of the space while still permitting the pivoting of the upper part (203) on the lower part (202).

### 5.3 Optical Reader Module

According to yet another aspect, the proposed technique also relates to an optical reader module which can be used jointly with the main module of the cash register described above. This module for example takes the form of a barcode reader and enables the merchant to scan the products that a customer wishes to purchase.

The proposed optical reader module (300) comprises two parts (301, 302) visible in FIG. 3. The part (301) is called a fixed part in the sense that it is intended to be fixedly attached to the main module (100) of a cash register according to the proposed technique. In one particular embodiment, the fixed attachment of these two parts can for example be obtained by means of a linking part, mounted beneath the foot (101) of the main module and beneath the fixed part (301) of the optical reader module, and connecting these two elements (101, 301) to each other. Advantageously, the profile of the fixed part (301) at least partly follows the profile of the foot (101) of the main module so that these two elements (101, 301) mutually form, on the plane on which they are placed, a space for the installation of this linking part. In this way, the linking part cannot be seen once is it is mounted and this space can also be profitably used for the passage of various cables. The other part (302) of the optical reader module (300) is a detachable part comprising the optical reader device, for example a barcode reader. This detachable part (302) is presented with reference to FIG. 5 in one particular embodiment.

The fixed part (301) and the detachable part (302) have complementary means to enable a temporary fixed attachment of these two elements (301, 302). These fixed attachment means are presented with reference to FIG. 6 in one particular embodiment of the proposed technique. They entail cooperation between complementary shapes (302, 304) and/or magnets (305, 306) which maintain and accurately center the detachable part (302) when it rests on the fixed part (301). In this way, the cash register preserves a consistent and integrated aspect when these two parts (301, 302) of the optical reader module (300) are fixedly attached. Besides, the optical reader module can be used to scan the products even in this configuration, through the positioning of the lens (307) of the optical reader device and through the shaping and sizing of the detachable part (302) as shown for example with reference to FIGS. 6 and 7. Naturally, the merchant, when he so wishes, can detach the detachable part (302), and therefore the optical reader device, from the fixed part (301), for example to scan a product which is too bulky to be presented before the cash register.

### 5.4 Examples of Configurations of Modular Cash Registers

As an illustratory but non-exhaustive example, referring to FIGS. 7 to 10, we present different examples of possible configurations of cash registers according to the proposed technique in different cases of use.

FIG. 7 shows a three-quarter view of a cash register in one particular embodiment of the proposed technique. This cash register comprises, in addition to the main module, the two complementary modules namely the payment module and the optical reader module. The cash register is presented in its compact form: the payment module is fixedly attached to the main module and the detachable part of the optical reader module rests on its fixed part. As explained above, even in this compact configuration, the cash register keeps an integrated and consistent appearance and remains fully operational: the products can be scanned in being presented before the lens of the optical reader module and the payment terminal can pivot to be presented so as to be facing the customer (this figure shows the space between the base of the payment module and the central unit of the main module as well as the cavity present in the flank of the central unit which permits this 180° pivoting). Besides, the main module integrates a printer for cash receipts and it also has an additional screen oriented towards the customer.

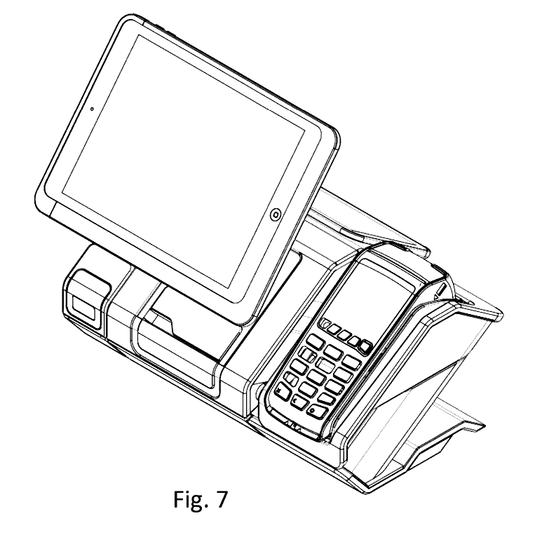

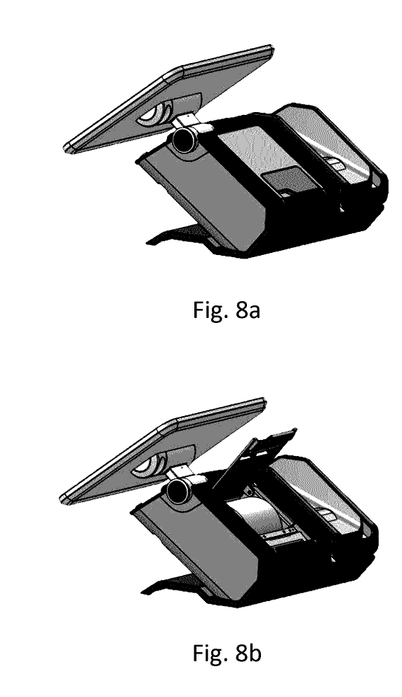

FIGS. 8a and 8b present a cash register according to another particular embodiment of the proposed technique. This cash register does not comprise any optical reader module. FIGS. 8a and 8b explain a situation in which the touchpad tablet is tilted rearwards into its loading position which enables access to the hatch enabling for example the replacement of the paper roll for the printer. The tilting movements between the loading position and the position of use have no effect on the adjustment made by the merchant to adjust the inclination of his tablet in use mode.

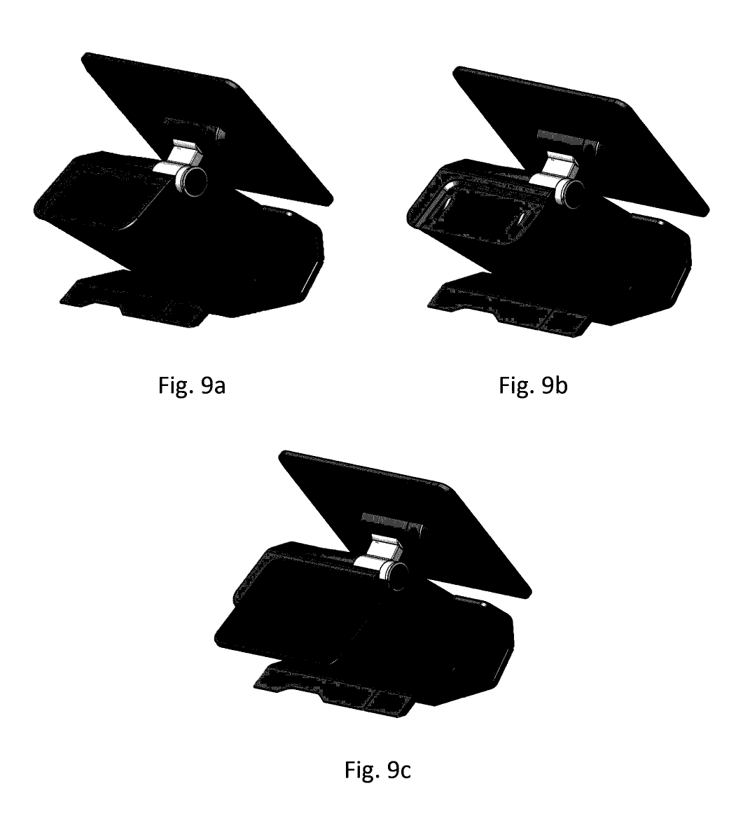

FIGS. 9a, 9b and 9c present a cash register according to yet another particular embodiment of the proposed technique. This cash register does not comprise any payment module. The cash register is seen from the customer's side in different situations: without an additional screen but with a cover enabling the fastening means of such a screen to be masked (FIG. 9a), without additional screen but with the cover removed (FIG. 9b) and finally with an additional screen (9c).

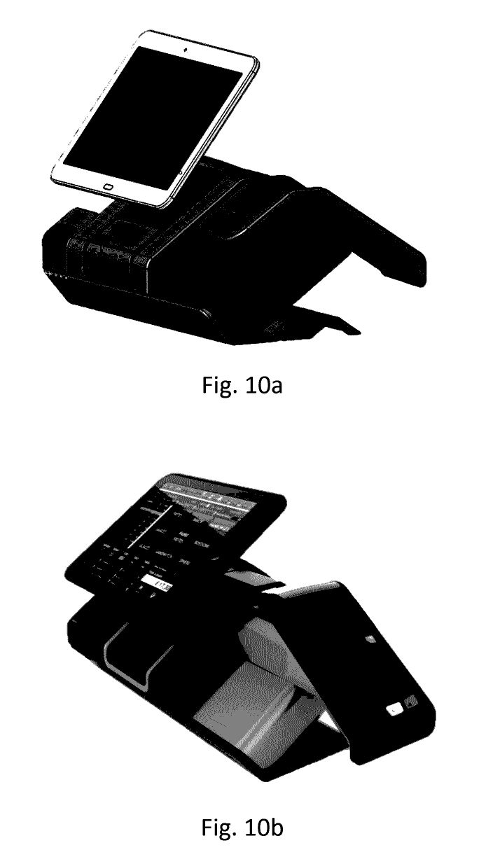

FIGS. 10a and 10b show a cash register according to yet another particular embodiment of the proposed technique. This cash register comprises, in addition to the main module, the two complementary modules, namely the payment module and the optical reader module. These figures show the tablet oriented in portrait mode (FIG. 10a) or landscape mode (FIG. 10b) as well as different orientations of the pivoting base of the payment module, enabling a payment terminal to be presented to a customer while keeping this payment terminal integrated into the cash register.

The proposed technique therefore relates to a highly modular cash register offering great flexibility to the merchant.

The main module firstly is upgradable. It may or may not integrate a printer for cash receipts, an additional screen for customers can be added on easily and quickly and the touchpad tablet which serves as a core for the device can easily be replaced by a more recent model or by a model from another manufacturer because of its interchangeable support.

Besides, complementary modules can be transplanted onto the main module depending on needs proper to each merchant. These complementary modules comprise a payment module for the integration of a payment terminal and an optical reader module. As described above, these complementary modules can be fixedly attached on either side of the main module or again they can also be used in a mode where they are detached from the main module. The proposed technique therefore makes it possible to very easily and simply assemble cash registers “to measure” and can be adapted to numerous configurations of counters and spaces. Besides, the complementary modules are sized and shaped so that the cash register keeps an integrated and consistent appearance when they are fixedly attached to its main module. These complementary modules are optional. Thus the cash register of the proposed technique can meet a large number of needs, ranging from the basic need, where only one main module and its tablet suffice, to the more developed configuration which also requires payment solutions and/or optical reading solutions.

1. A main module of a cash register implemented by means of a tablet type digital touchpad device, the module comprising:
a central unit;
an interchangeable support adapted to maintaining said digital touchpad device; and
a hinged arm having a first extremity linked by a first pivot link to said central unit, and a second extremity linked by a second pivot link to a receiving plate to which said interchangeable support is fixed.

2. A main module of a cash register according to claim 1, wherein said central unit integrates a printer and has, on one of its faces, an outlet slot for print-outs from said printer, and a hatch for access to a housing for loading at least one paper roll for said printer.

3. A main module of a cash register according to claim 2, wherein said first pivot link is a two-position pivot used to make said digital touchpad device tilt, by means of said hinged arm, into:
a first position in which the digital touchpad device has an inclination favorable to its use; and
a second position in which the digital touchpad device is tilted in such a way that said access hatch to the housing for loading at least one paper roll of said printer is accessible.

4. A main module of a cash register according to claim 1, wherein said second extremity of said hinged arm and said receiving plate are furthermore linked by a third pivot link enabling the rotation of said receiving plate, and therefore of said digital touchpad device, in its plane of inclination.

5. A main module of a cash register according to claim 1, wherein said central unit comprises means for attaching an additional screen.

6. A payment module to be coupled to a main module of a cash register according to claim 1, the payment module including a receiving base for a payment terminal, said base comprising:
a lower part; and
an upper part comprising a housing capable of receiving said payment terminal, said upper part being linked by a pivot link to said lower part, said pivot link enabling said upper part to pivot in the substantially horizontal plane on said lower part.

7. An optical reader module to be coupled to a main module of a cash register according to claim 1, the optical reader comprising:
a fixed part; and
a detachable part, comprising an optical reader device, said fixed and detachable parts comprising complementary means for the temporary, fixed attachment of said parts.

8. An optical reader module according to claim 7, wherein said complementary means of temporary fixed attachment of said fixed and detachable parts of the optical reader module take the form of complementary shapes capable of cooperating with each other and/or the form of magnets.

9. A cash register implemented by means of a tablet type digital touchpad device, wherein said digital touchpad device is fixed to a main module according to claim 1, and wherein said cash register comprises at least one of:
a payment module on which a payment terminal is positioned, the payment module comprising a receiving base for a payment terminal having a lower part and an upper part with a housing capable of receiving said payment terminal, said upper part being linked by a pivot link to said lower part, said pivot link enabling said upper part to pivot in the substantially horizontal plane on said lower part; and
an optical reader module that is coupled to said main module and that includes a fixed part and a detachable part that has an optical reader device, said fixed and detachable parts comprising complementary means for the temporary, fixed attachment of said parts.
